(19) United States
(12) Patent Application Publication
(10) Pub. No.: US 2014/0151319 A1
(43) Pub. Date: Jun. 5, 2014

(54) CHILD'S CUP

(71) Applicant: Marty DeFelice, Sarasota, FL (US)

(72) Inventor: Marty DeFelice, Sarasota, FL (US)

(21) Appl. No.: 14/173,356

(22) Filed: Feb. 5, 2014

Related U.S. Application Data
(63) Continuation-in-part of application No. 13/450,785, filed on Apr. 19, 2012, now abandoned.

(51) Int. Cl. A61J 9/04; A61J 9/00

(52) U.S. Cl. CPC A61J 9/04; A61J 9/006
USPC 215/11.5

(57) ABSTRACT

A child's cup including an inflatable bladder within the cup and separated from the contents of the cup, and a valve between the contents of the cup and the exterior of the cup and closed when the cup is not in use to resist deflation of the bladder.

This Application is a Continuation in Part of application Ser. No. 13/450,785 filed on Apr. 19, 2012, the contents of which are incorporated herein in the entirety.

### FIELD OF THE INVENTION

The present invention relates to a child's cup and more particularly to such a cup provided with a straw and a bladder with means to expand the bladder when the straw is in use.

### BACKGROUND OF THE INVENTION

A child's straw cup is a cup commonly used by children 1 to 4 years old as a transition between a nipple fitted bottle and an open cup. Previous child's straw cups have generally included a straw or mouthpiece, a bottle the interior of which is accessible to the straw and mouthpiece, and a vent to equalize pressure between the outside and inside of the bottle to allow liquid to flow from the straw or mouthpiece. There have been no child cups which have included a bladder which inflates as the cup is being used and which remains inflated during periods of non-use.

### SUMMARY OF THE INVENTION

The present invention provides a child's cup which includes a bladder within the cup that inflates as liquid is withdrawn from the cup and which remains a inflated when suction stops. Unlike the construction of Sippy cups and baby bottles, the bladder does not contain liquid and the liquid contents of the bottle are within the bottle to cup but exterior to the bladder. The bladder is not intended to fill the area in the bottle that is increased as liquid is withdrawn. The bladder is constructed of a flexible material such as LLDPE or the like and provides a material to contain indicia such as advertising or the like which becomes fully visible as the bladder inflates.

A valve is provided and is opened as the bladder inflates and liquid is removed from the bottle and is closed and remains closed when liquid is no longer being removed from the bottle. The valve operates to permit the user to inflate the bladder to a degree higher than if there were no valve and the valve operates to maintain the pressure in the bladder to extend the effect of the inflated bladder and to thereby increase the aesthetic impact of the bladder.

### BRIEF DESCRIPTION OF THE DRAWINGS

FIG. 1 is a cross sectional view of the child's cup of the present invention;

FIG. 1A is a fragmentary view of a portion of the structure shown in FIG. 1 and illustrating the valve in a closed position;

FIG. 1B is a fragmentary view similar to FIG. 1A but illustrating the valve in an open position;

FIG. 2 is a fragmentary view similar to FIGS. 1A and 1B but illustrating the mouthpiece in a closed position;

FIG. 3 is an exploded view of the child's cup of the present invention;

FIG. 4 is a view illustrating the bladder in the cup in an expanded condition;

FIG. 5 is an elevational view of the child's cup of the present invention as seen from the top of FIG. 1 with the straw cut away to better illustrate the opening to atmosphere formed in the cap of the cup; and

FIG. 6 is a perspective view of the valve of the child's cup of the present invention.

### DETAILED DESCRIPTION OF A PREFERRED EMBODIMENT

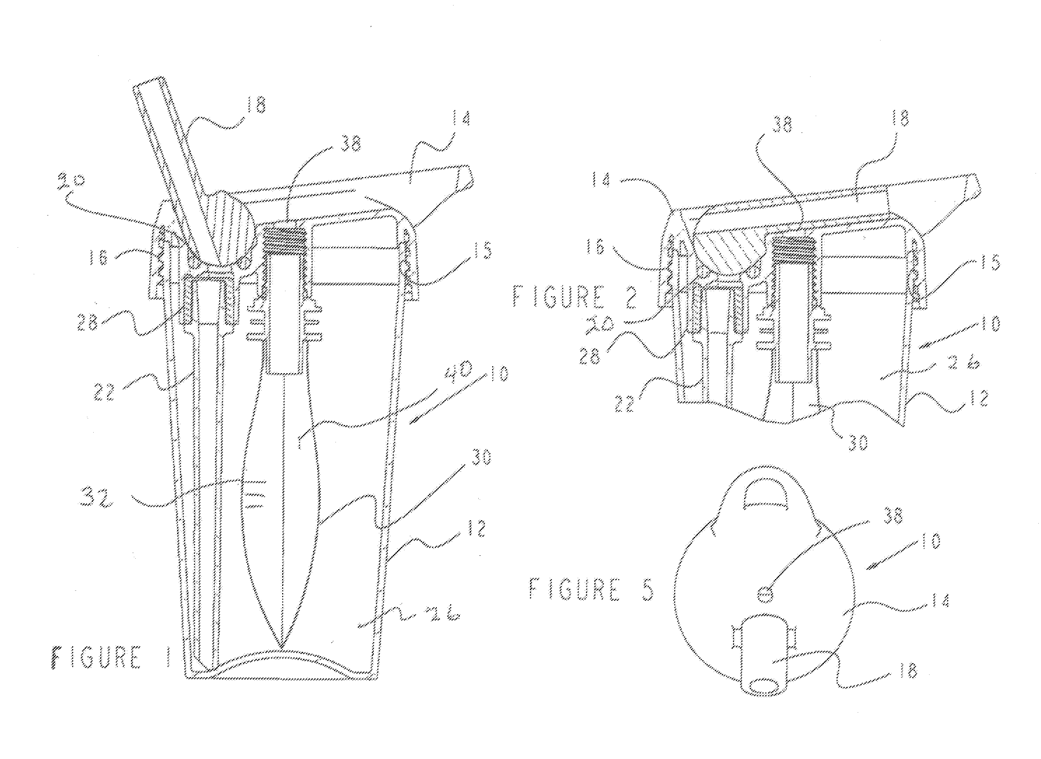

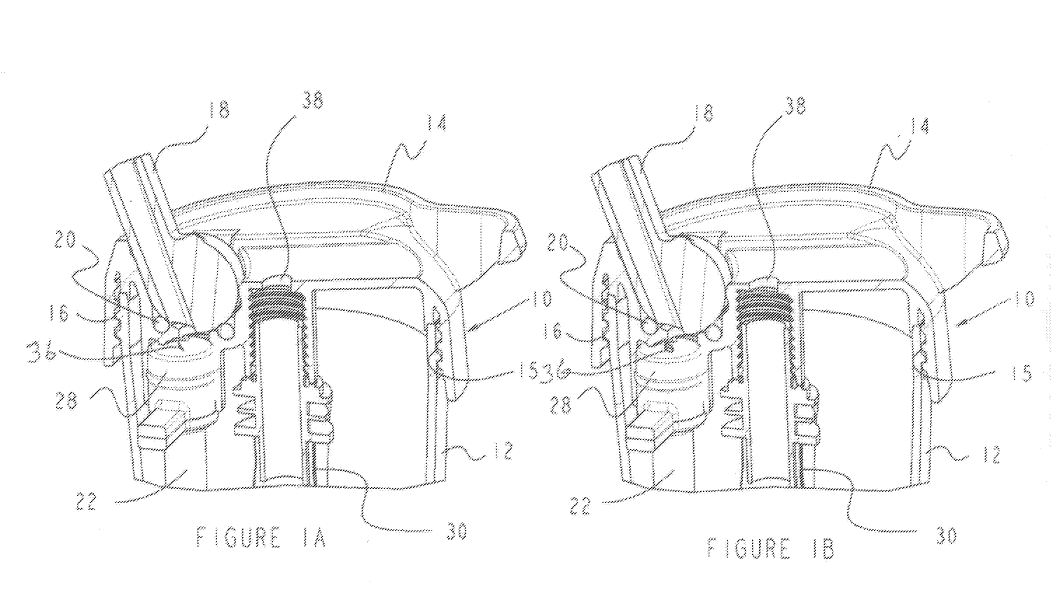

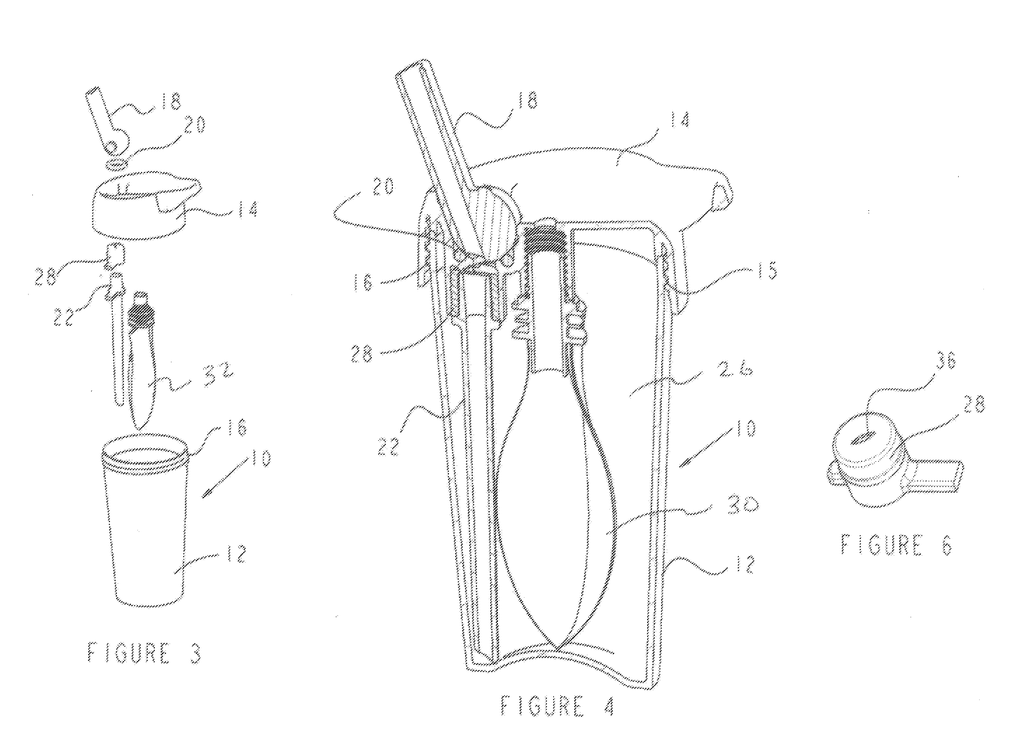

Referring to FIGS. 1 and 2, a child's cup 10 consists of a bottle 12 closed by a cap 14. The cap 14 is retained on the bottle 12 by a cap thread 15 screwed to a bottle thread 16.

Still referring to FIGS. 1 and 2, a mouthpiece 18 is held in the cap 14 by an interference fit creating a mouthpiece body seal at 20. A low-pressure area in the mouthpiece 18 is created by the user. This low-pressure area is translated through a suction straw 22. The low-pressure area in the mouthpiece 18 relative to pressure in an internal cavity 26 of the bottle 12 causes a valve 28 to open, allowing liquid to outflow from the bottle 12. As liquid is consumed from the mouthpiece 18, the outflow creates a low-pressure area in internal cavity 26 of the bottle 12. A bladder 30 is connected to the outside atmosphere through an atmosphere vent 38.

As best seen FIGS. 1A and 1B, the valve 28 includes a slit 36 which opens as the position shown in FIG. 1B and FIG. 6 in response to increases in the pressure differential across the valve 28 and is closed when the pressure differential across the silt 36 equalizes. When the user stops sucking on the mouthpiece 18, the internal vacuum within the bottle 12 is lost, the pressure across the valve 28 equalizes and the valve 28 moves to a closed position as best seen in FIG. 1A.

Referring to FIG. 1 the air 40 in the bladder 30 is allowed to escape through an atmosphere vent 38 (FIG. 5) formed in the cap 14. The internal cavity 26 and the suction straw 22 are then substantially equal to atmospheric pressure. The seal provided by the closed valve 28 is broken only if the cap 14 is unscrewed from the bottle 12. With the valve 28 closed and the cap 14 in place, the interior of the bottle 12 is sealed from the exterior of the bottle 12 and the bladder 30 will remain inflated.

As shown in FIGS. 1A and 1B the slit 36 of the valve 28 is movable between a closed position and an open position by changes in the pressure differential across the valve, 28. The force imposed on the valve 28 by its natural resiliency must be sufficiently weak in permit the child sucking on the bottle 12 to create a reduction of pressure in the bottle 12 sufficient to permit the valve 28 to open. When the child stops sucking, the atmospheric pressure that is permitted to return to the bottle 12 causes the valve flap 36 to close. As long as there is atmospheric pressure in the bottle 12 the valve 28 will be held in a closed position to keep the bottle 12 from leaking in any orientation of the bottle 12.

The valve 28 is a significant element of the present invention. The valve 28 allows the user to inflate the bladder 30 to a degree higher than if there were no valve 28 and more importantly the valve 28 maintains the pressure in the bladder 30 to extend the effect and the aesthetic impact of the bladder 30. If air were allowed back into the bottle 12 through the valve 28 the pressure within the bottle 12 would cause the bladder 30 to deflate. The valve 28 by remaining closed prevents air from returning to the bottle 12 and therefore keeps the bladder 30 inflated. As best seen in FIG. 1 indicia 32 can be provided on the bladder 30 to be fully exposed when the bladder 30 is inflated.

It is important that bladder 30 be formed of a material that will resist expansion of the bladder only slightly as the child withdraws liquid through the straw 18. The material must also permit the bladder 30 to remain expanded for a time when the child is no longer using the straw 18. A material that has been found to have the necessary characteristics for the bladder 30 is 2 mil of coextruded LLDPE.

It should be apparent to one skilled in the art that although a preferred child's cup has been described featuring a cup provided with a bladder that inflates upon liquid being removed from the bottle and which remains inflated when the liquid removal stops and that changes and modifications could be made to the preferred embodiment which has been shown and described without departing from the spirit or the scope of the invention as defined in the appended claims.

1. A child's cup comprises:
a) a bottle and a cap for said bottle;
b) a mouthpiece retained by said cap and opening to the interior of said bottle; and
c) a valve between the contents of the bottle and the mouthpiece and operable to close upon the interior of bottle being opened to atmospheric pressure to seal the contents of the bottle from the mouthpiece;
d) a bladder disposed in the interior of said bottle and having an interior open to the atmosphere exteriorly said bottle;
e) said valve being operable upon closing to maintain the pressure in the inflated bladder.

2. The child's cup as defined in claim 1 and in which the contents of said bottle are disposed in the interior of said bottle and exteriorly of said bladder.

3. The child's cup as defined in claim 1 and further comprising said bladder having an interior separated from the contents of said bottle and open to atmosphere.

4. The child's cup as defined in claim 1 and further comprising a cap for closing said bottle and a mouthpiece extending exteriorly from said cap.

5. The child's cup as defined in claim 1 and further comprising a straw extending from the interior of said bottle and connected with said mouthpiece.

6. The child's cup as defined in claim 5 and said valve being disposed between said mouthpiece and said straw.

7. The child's cup as defined in claim 1 and including indicia provided on said bladder.
